(19) United States
(12) Patent Application Publication
(10) Pub. No.: US 2010/0238091 A1
(43) Pub. Date: Sep. 23, 2010

(54) INFORMATION PROCESSING APPARATUS, DISPLAY PROCESSING METHOD, AND COMPUTER PROGRAM PRODUCT

(76) Inventor: Goro KATSUYAMA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/696,747

(22) Filed: Jan. 29, 2010

(30) Foreign Application Priority Data
Mar. 18, 2009 (JP) 2009-067132

(51) Int. Cl. G09G 5/00

(52) U.S. Cl. 345/1.3

(57) ABSTRACT

It is decided whether an information processing apparatus is connected to an external device. When the information processing apparatus is connected to the external device, external display data is received from the external device. The external display data is a part of display data that forms a screen to be displayed on a display unit and includes a display element that does not hinder cooperation with the external device. A display control unit forms the screen by using the external display data and causes the display unit to display the screen.

### CROSS-REFERENCE TO RELATED APPLICATIONS

The present application claims priority to and incorporates by reference the entire contents of Japanese Patent Application No. 2009-067132 filed in Japan on Mar. 18, 2009.

### BACKGROUND OF THE INVENTION

1. Field of the Invention

The present invention relates to an information processing apparatus, a display processing method, and a computer program product.

2. Description of the Related Art

Various types of information processing apparatuses such as copiers, personal computers, and mobile terminals are known in the art. The screens that are typically displayed on the display units of these apparatuses have generally fixed configurations (see, for example, Japanese Patent Application Laid-open No. H10-40440). More specifically, the screens contain various display elements, such as display-use elements that used only to be seen by the user and operation elements such as icons and tabs that are to be operated by the user when performing certain operations such as input operation, and the arrangement of the display elements on the screens in the conventional information processing apparatuses was substantially fixed.

Recently, it has become possible for a user to connect a mobile terminal or the like to another device and perform various operations on the device by using the mobile terminal.

Because the screens that are typically displayed on the display unit of the conventional mobile terminal has a generally fixed configuration, when the mobile terminal is connected to another device, the screens displayed on the display units of the mobile terminal did not have elements suitable to operate the device, which made operations of the mobile terminal complicated.

### SUMMARY OF THE INVENTION

It is an object of the present invention to at least partially solve the problems in the conventional technology.

According to an aspect of the present invention, there is provided an information processing apparatus including a display unit; a connection determining unit that determines whether the information processing apparatus is connected to an external device; a receiving unit that receives, when the information processing apparatus is connected to the external device, external display data from the external device, wherein the external display data is a part of display data that forms a screen to be displayed on the display unit and includes a display element that does not hinder cooperation with the external device; and a display control unit that forms the screen by using the external display data and causes the display unit to display the screen.

According to another aspect of the present invention, there is provided a display processing method to be implemented on an information processing apparatus having a display unit. The display processing method including determining whether the information processing apparatus is connected to an external device; receiving, when the information processing apparatus is determined to be connected to the external device at the determining, external display data from the external device, wherein the external display data is a part of display data that forms a screen to be displayed on the display unit and includes a display element that does not hinder cooperation with the external device; and forming the screen by using the external display data and causing the display unit to display the screen.

According to still another aspect of the present invention, there is provided a computer program product including computer program codes stored on a computer-readable recording medium which when executed on a computer cause the computer to execute a display processing method to be implemented on an information processing apparatus having a display unit. The computer program codes causing the computer to execute determining whether the information processing apparatus is connected to an external device; receiving, when the information processing apparatus is determined to be connected to the external device at the determining, external display data from the external device, wherein the external display data is a part of display data that forms a screen to be displayed on the display unit and includes a display element that does not hinder cooperation with the external device; and forming the screen by using the external display data and causing the display unit to display the screen.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of the configuration an information processing apparatus according to a first embodiment of the present invention;

FIG. 2 is a flowchart of a display process according to the first embodiment;

FIG. 3A is a perspective view of a multifunction product (MFP);

FIG. 3B and FIG. 3C are schematic diagrams that explain how the information processing apparatus can be connected to the MFP shown in FIG. 3A;

FIG. 4A is a schematic diagram of a screen displayed on the MFP;

FIG. 4B and FIG. 4C are schematic diagrams that illustrate how screens are displayed on each of the MFP and the information processing apparatus shown in FIG. 3B and FIG. 3C respectively;

FIG. 5A is a perspective view of a car navigation device;

FIG. 5B and FIG. 5C are schematic diagrams that explain how the information processing apparatus can be connected to the car navigation device shown in FIG. 5A;

FIG. 6A and FIG. 6B are schematic diagrams that illustrate how screens are displayed on each of the car navigation device and the information processing apparatus shown in FIG. 5B or FIG. 5C respectively;

FIG. 7A is a perspective view of a tabletop PC;

FIG. 7B and FIG. 7C are schematic diagrams that explain how the information processing apparatus can be connected to the tabletop PC shown in FIG. 7A;

FIG. 8A and FIG. 8B are schematic diagrams that illustrate how screens are displayed on each of the tabletop PC and the information processing apparatus shown in FIG. 7B or FIG. 7C respectively;

FIG. 9A is a perspective view of a game console;

FIG. 9B is a schematic diagram that explains how the information processing apparatus can be connected to the game console shown in FIG. 9A;

FIG. 10 is a schematic diagram that illustrates how screens are displayed on each of the game console and the information processing apparatus shown in FIG. 9B;

FIG. 11A is a perspective view of a projector;

FIG. 11B and FIG. 11C are schematic diagrams that explain how the information processing apparatus can be connected to the projector shown in FIG. 11A;

FIG. 12A and FIG. 12B are schematic diagrams that illustrate how screens are displayed on each of the projector and the information processing apparatus shown in FIG. 11B or FIG. 11C respectively;

FIG. 13A is a perspective view of a sheet of electronic paper;

FIG. 13B is a diagram that explains how the information processing apparatus can be connected to the sheet of the electronic paper shown in FIG. 13A;

FIG. 14 is a schematic diagram that illustrates how screens are displayed on each of the sheet of the electronic paper and the information processing apparatus shown in FIG. 13B;

FIG. 15A is a perspective view of a sheet of electronic paper;

FIG. 15B is a diagram that explains how two sheets of the electronic paper can be connected to each other; and

FIG. 16 is a schematic diagram that illustrates how screens are displayed on each of the two sheets of the electronic paper shown in FIG. 15B.

### DETAILED DESCRIPTION OF THE PREFERRED EMBODIMENTS

Exemplary embodiments of the present invention are described in detail below with reference to the accompanying drawings.

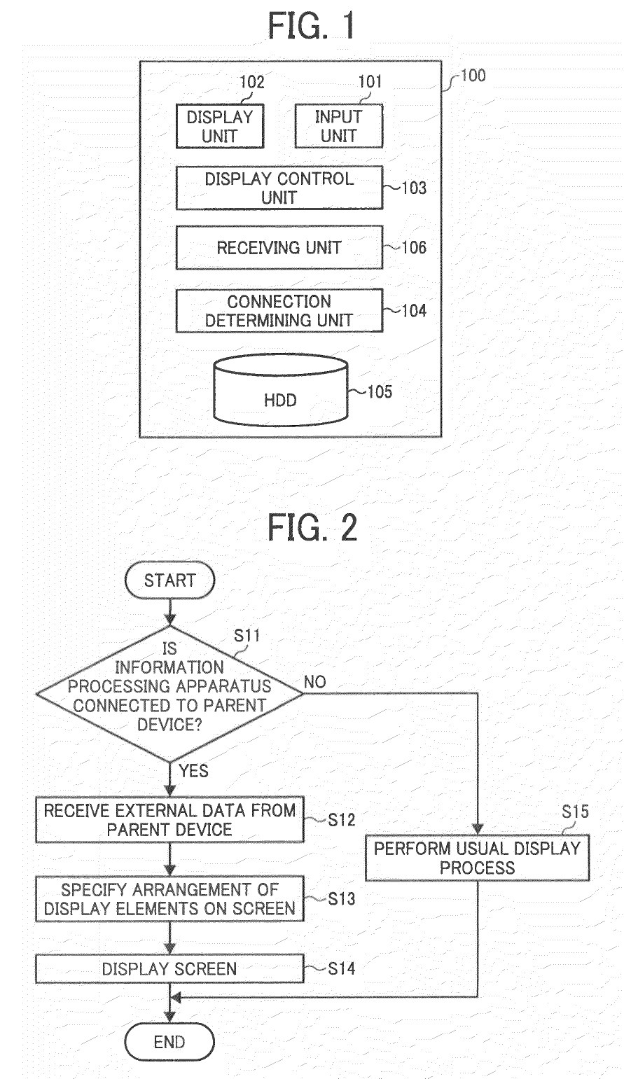

FIG. 1 is a functional block diagram of the configuration an information processing apparatus according to an embodiment of the present invention. An information processing apparatus 100 according to the present embodiment includes, as shown in FIG. 1, a display unit 102, an input unit 101, a display control unit 103, a connection determining unit 104, a hard disk drive (HDD) 105, and a receiving unit 106 as main units.

The display unit 102 is a device, such as a display device, that displays screens. The input unit 101 is an input device, such as a mouse or a keyboard for inputting data and instructions. Instead of using separate display device and input device, is allowable to use a touch-panel style input/display device that has functions of both the display device and the input device.

The connection determining unit 104 detects whether the information processing apparatus 100 is connected to an external device. More particularly, upon detecting a connection signal that is received when a connection to an external device is established, the connection determining unit 104 determines that the information processing apparatus 100 is connected to the external device.

The receiving unit 106, when the connection determining unit 104 detects that the information processing apparatus 100 is connected to an external device, receives external display data from external device.

The display control unit 103 controls display of screens on the display unit 102. The screens are created from display data. The display data can be the external display data, internal display data that is present within the information processing apparatus 100, or a combination of the external display data and the internal display data. Each of the external display data and the internal display data includes display elements. When displaying screens on the display unit 102 based on the display data, display elements created from the external display data are displayed in one area on the display unit 102 and display elements created from the internal display data are displayed in another area on the display unit 102.

In other words, the information processing apparatus 100 receives the external display data from the external device when the information processing apparatus 100 is connected to the external device, and displays display elements on a screen on the display unit 102 that are most likely used to operate the external device from the information processing apparatus 100. Examples of display of the display elements on a screen are described later in detail.

The display elements include both the display-use elements and the operation elements. The operation elements can be icons, tabs, and list boxes, etc. The display elements can be smaller elements, such as icons, or can be bigger elements that define a wider region on the screen.

The HDD 105 is a recording medium that stores therein the external display data and internal display data and various other data.

A display process according to the present embodiment is described below with reference to FIG. 2.

To begin with, the connection determining unit 104 determines whether the information processing apparatus 100 is connected to an external device (hereinafter, “parent device”) (Step S11). If the information processing apparatus 100 is not connected to the parent device (No at Step S11), a usual display process is performed (Step S15).

If the information processing apparatus 100 is connected to the parent device (Yes at Step S11), the receiving unit 106 receives external display data from the parent device (Step S12) and the display control unit 103 determines positional arrangement of display elements created from the external display data on a screen to be displayed on the display unit 102 (Step S13). The positional arrangement is determined depending on how the information processing apparatus 100 is connected to the parent device. Finally, the display control unit 103 displays the screen including the display elements on the display unit 102 (Step S14).

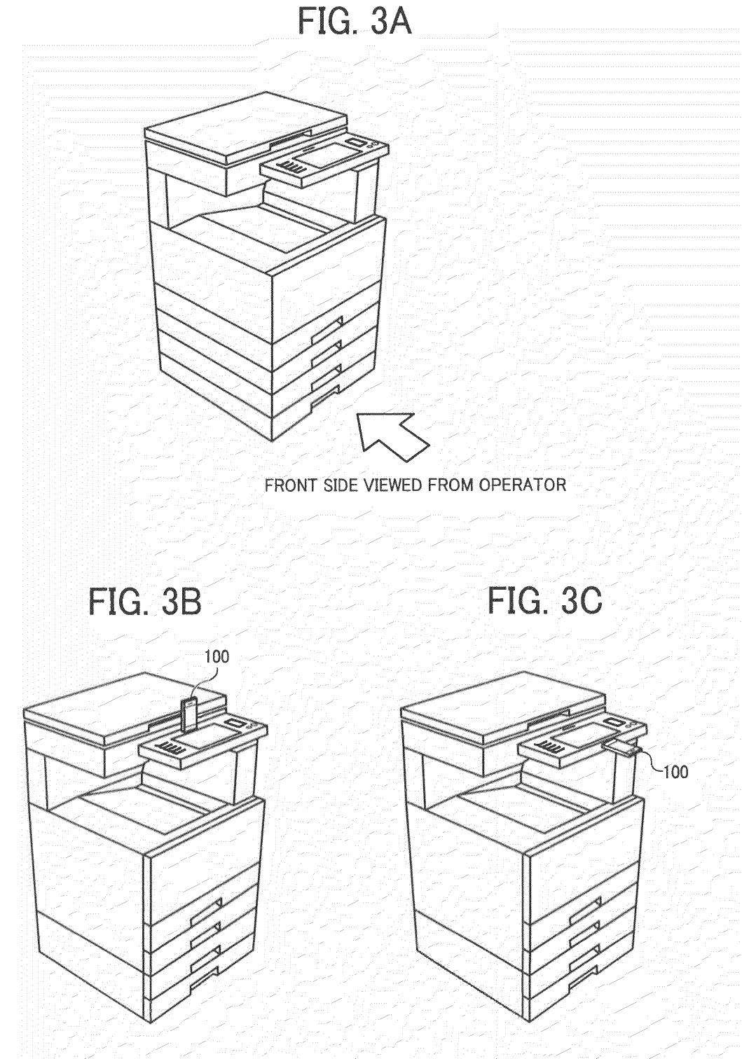

Examples of display of the screen including the display elements are described in detail below. FIG. 3A is a perspective view of a multifunction product (MFP). FIGS. 3B and 3C are diagrams that explain how the information processing apparatus 100 as a mobile terminal can be connected to the MFP as a parent device. As shown in FIG. 3B the mobile terminal can be connectable to the upper surface of an operation display unit of the MFP in a vertical posture, or as shown in FIG. 3C the mobile terminal can be connected to the front surface of the operation display unit in a horizontal posture.

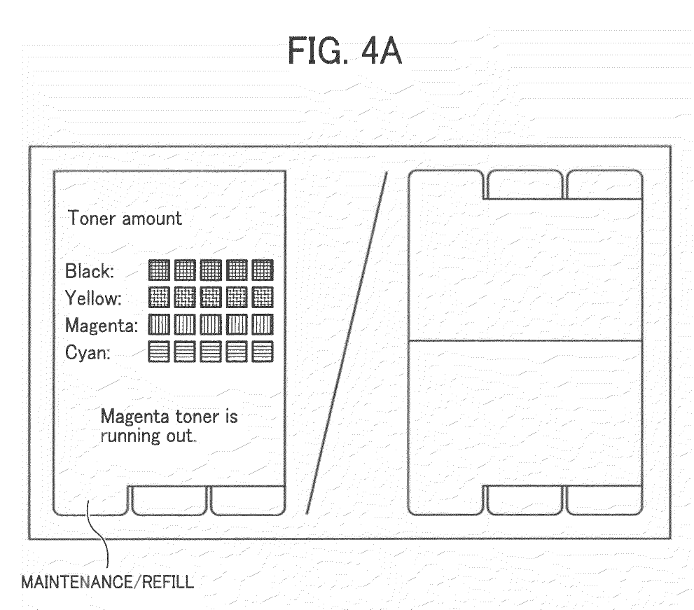

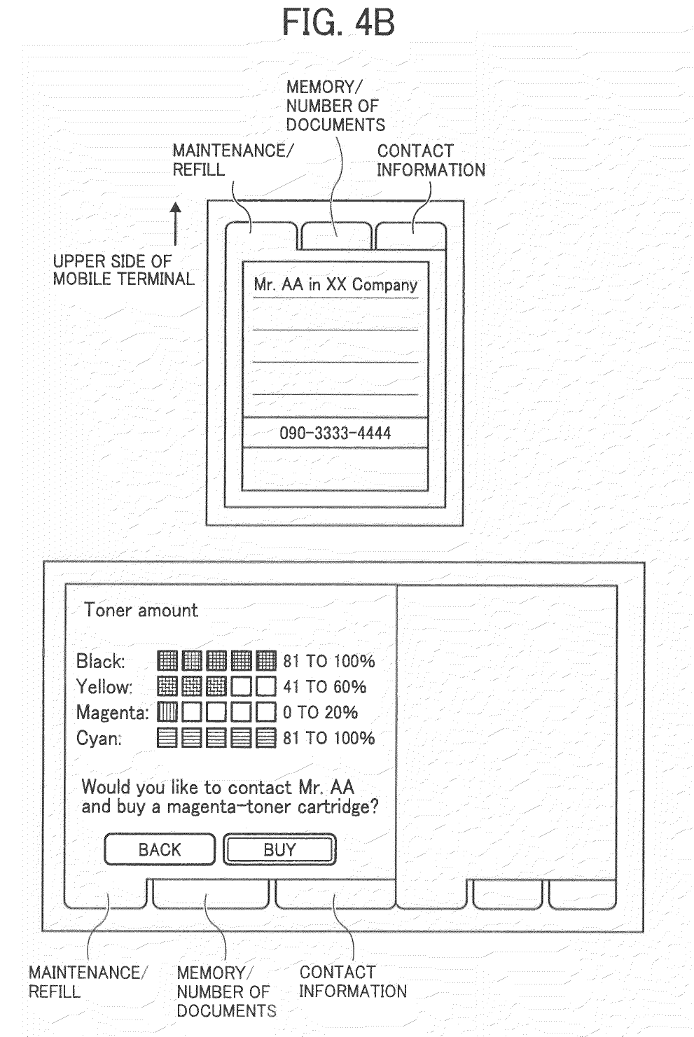

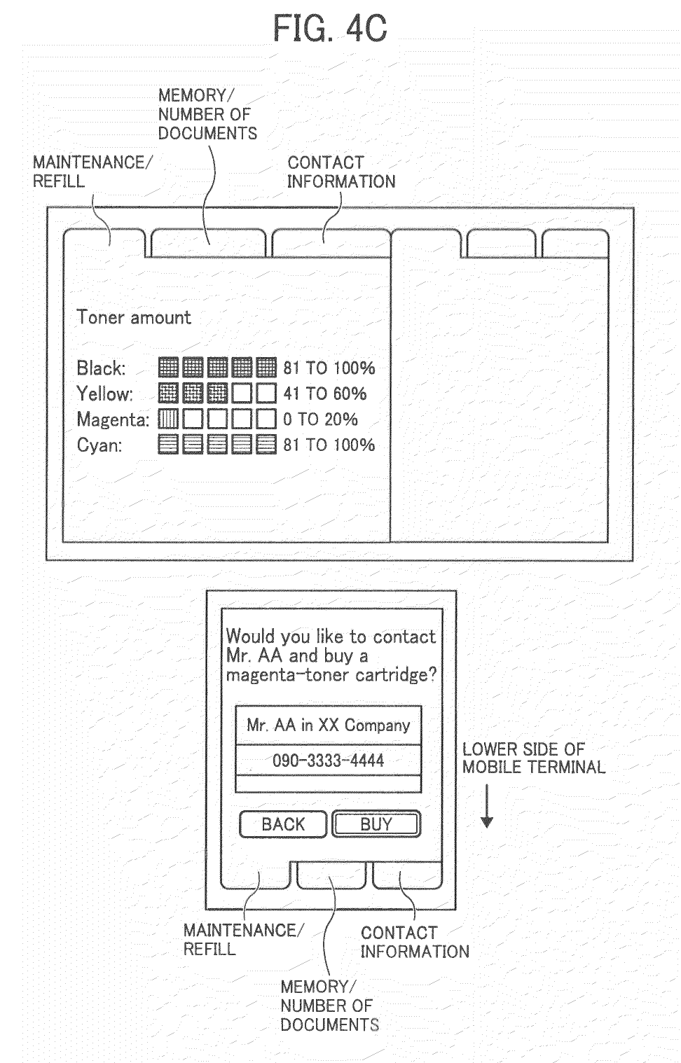

FIG. 4A is a schematic diagram of a screen displayed on the operation display unit of the MFP. FIG. 4B is a schematic diagram that illustrates how information is displayed on the MFP and the mobile terminal when the mobile terminal is connected to the upper surface of the operation display unit of the MFP in a vertical posture in the manner shown in FIG. 3B. FIG. 4C is a schematic diagram that illustrates how information is displayed on the MFP and the mobile terminal when the mobile terminal is connected to the front surface of the operation display unit of the MFP in a horizontal posture in the manner shown in FIG. 3C.

As shown in FIGS. 4B and 4C, the display elements are displayed in cooperative manner on both the MFP and the mobile terminal in such a manner that the display elements on the screen of each device do not hinder the cooperation with the other device. More particularly, the display elements on the screen of each device are not associated with each other.

More specifically, if the mobile terminal is connected to the upper surface of the operation display unit of the MFP in a vertical posture in the manner shown in FIG. 3B, as shown in FIG. 4B, the MFP displays tabs, which are the display elements, at the lower side, i.e., nearer to the user on its screen, while the mobile terminal displays tabs at the upper side on its screen so that the user can operate the tabs easily.

If the mobile terminal is connected to the front surface of the operation display unit of the MFP in a horizontal posture in the manner shown in FIG. 3C, as shown in FIG. 4C, the MFP displays tabs, which are the display elements, at the upper side on its screen, while the mobile terminal displays tabs at the lower side on its screen so that the user can operate the tabs easily.

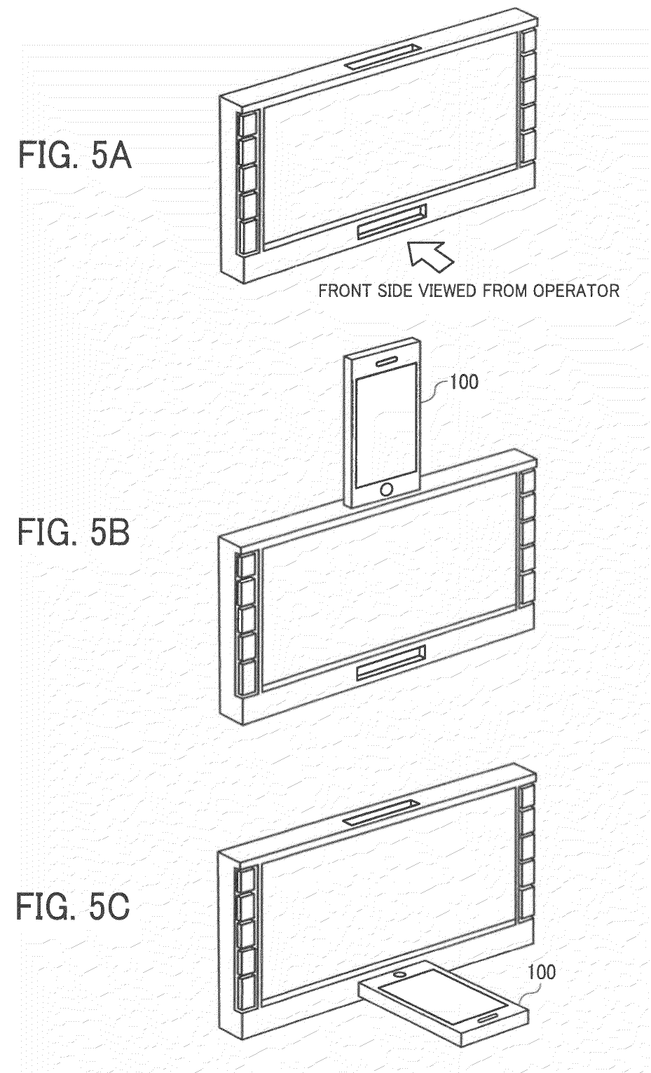

FIG. 5A is a perspective view of a car navigation device. FIGS. 5B and 5C are diagrams that explain how the information processing apparatus 100 as a mobile terminal can be connected to the car navigation device as a parent device. As shown in FIG. 5B the mobile terminal can be connected to the upper edge of the car navigation device in a vertical posture, or as shown in FIG. 5C the mobile terminal can be connected to the front surface of the car navigation device in a horizontal posture.

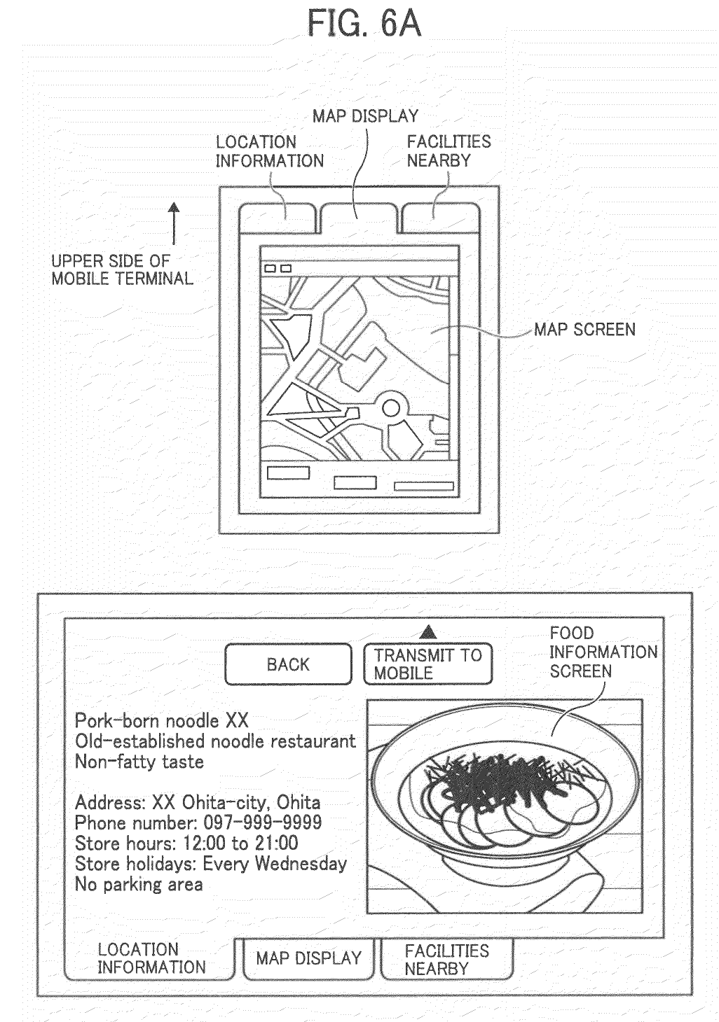

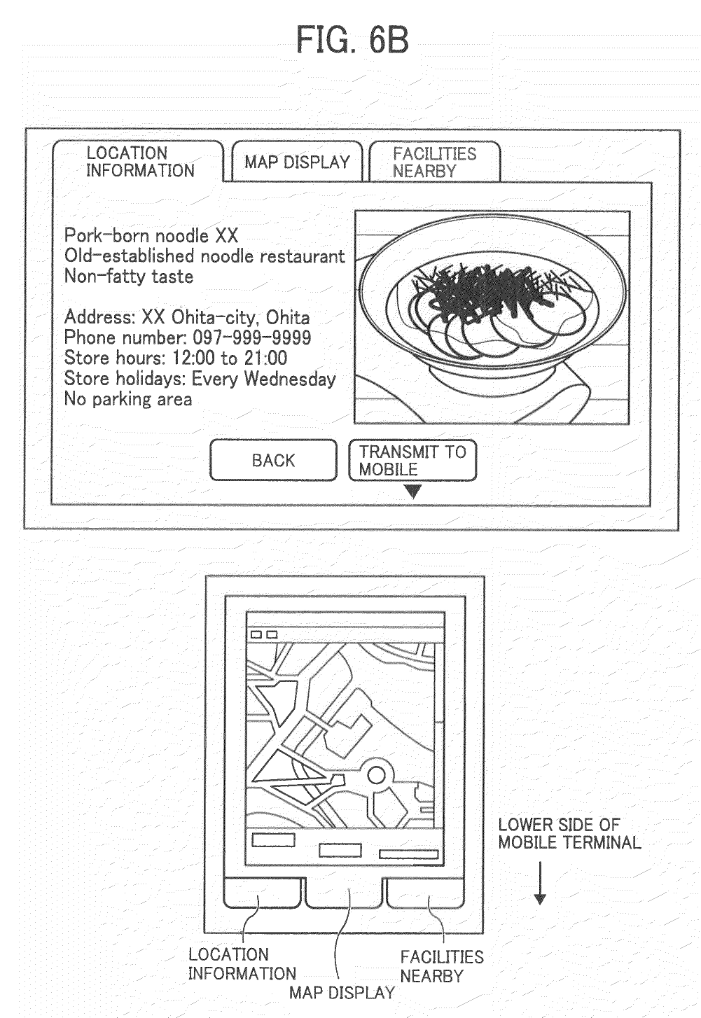

FIG. 6A and FIG. 6B are schematic diagrams that illustrate how screens are displayed on each of the car navigation device and the mobile terminal shown in FIG. 5B and FIG. 5C respectively. FIG. 6A is a schematic diagram that illustrates how information is displayed on the car navigation device and the mobile terminal when the mobile terminal is connected to the upper edge of the car navigation device in vertical posture in the manner shown in FIG. 5B. FIG. 6B is a schematic diagram that illustrates how information is displayed on the car navigation device and the mobile terminal when the mobile terminal is connected to the front surface of the car navigation device in a horizontal posture in the manner shown in FIG. 5C.

As shown in FIGS. 6A and 6B, positional arrangement of the display elements on the screen of each device is such that it does not hinder the cooperation with the other device. More particularly, a map screen is displayed on the mobile terminal while a food information screen that is different from the map screen is displayed on the car navigation device.

The arrangement positions of the display elements, such as tabs, on the screen of each device shown in FIGS. 6A and 6B are the same as those shown in FIGS. 4B and 4C.

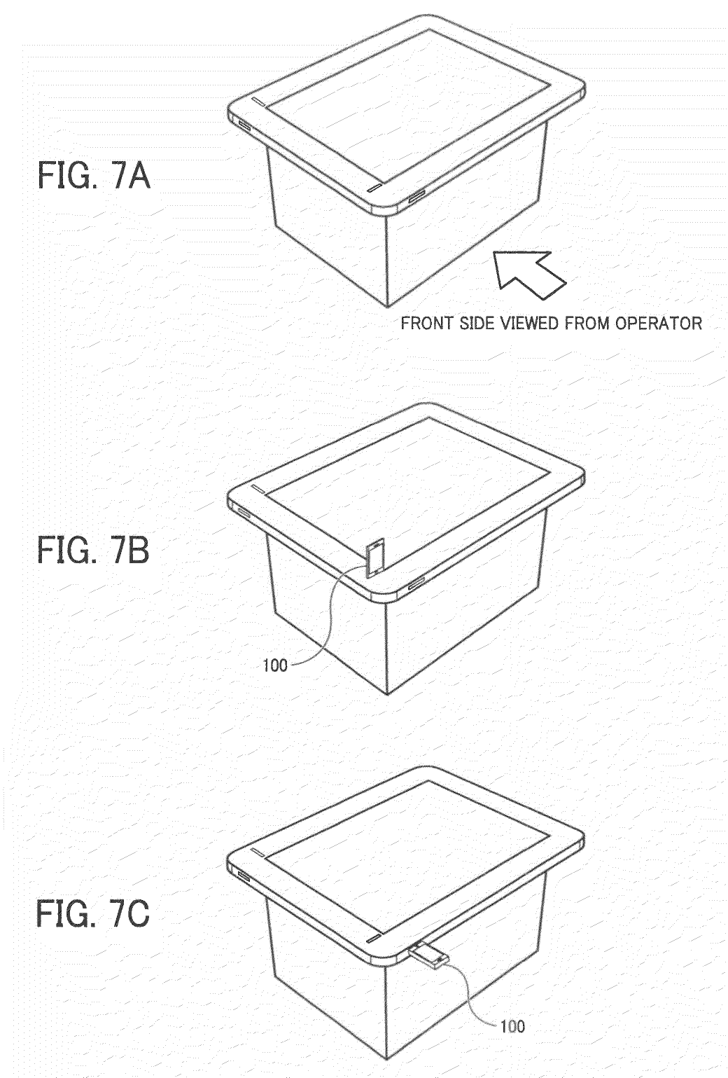

FIG. 7A is a perspective view of a tabletop PC. FIGS. 7B and 7C are diagrams that explain how the information processing apparatus 100 as a mobile terminal can be connected to the tabletop PC as a parent device. As shown in FIG. 7B the mobile terminal can be connected to the upper surface of the tabletop PC in a vertical posture, or as shown in FIG. 7C the mobile terminal can be connected to the front surface of the tabletop PC in a horizontal posture.

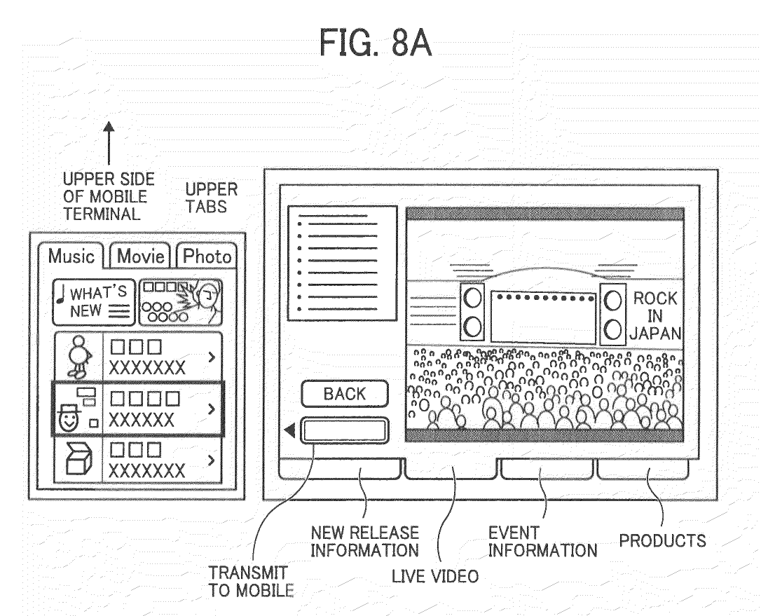

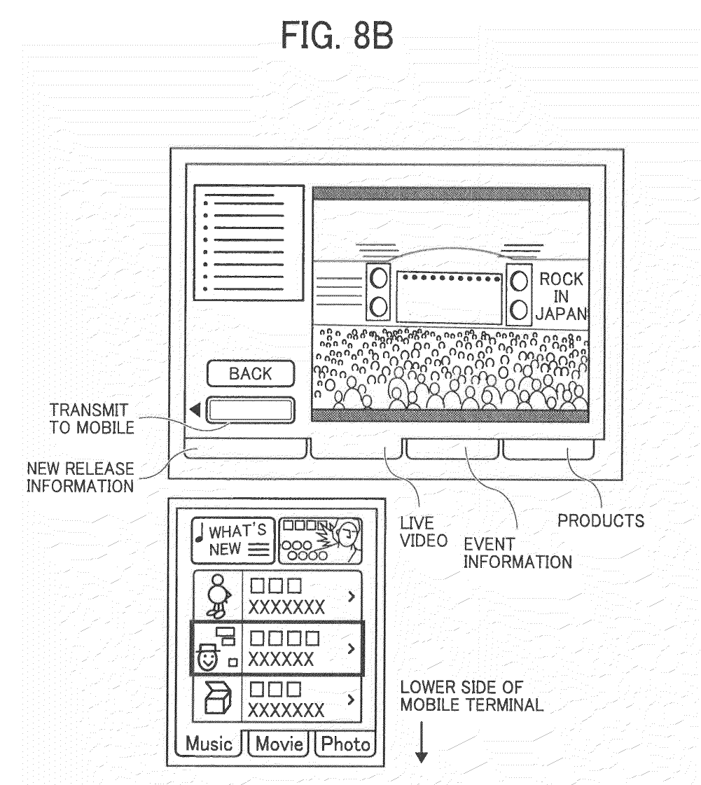

FIG. 8A and FIG. 8B are schematic diagrams that illustrate how screens are displayed on each of the tabletop PC and the mobile terminal shown in FIG. 7B and FIG. 7C respectively. FIG. 8A is a schematic diagram that illustrates how information is displayed on each of the tabletop PC and the mobile terminal when the mobile terminal is connected to the upper surface of the tabletop PC in vertical posture in a manner shown in FIG. 7B. FIG. 8B is a schematic diagram that illustrates how information is displayed on each of the tabletop PC and the mobile terminal when the mobile terminal is connected to the front surface of the tabletop PC in a horizontal posture in a manner shown in FIG. 7C.

In the examples shown in FIGS. 8A and 8B the display elements on the screen of each device are displayed in such a manner that the display elements do not hinder the cooperation with the other device in the same manner as the examples shown in FIGS. 4B and 4C.

The arrangement positions of the display elements, such as tabs, on the screen of each device shown in FIGS. 8A and 8B are the same as those shown in FIGS. 4B and 4C.

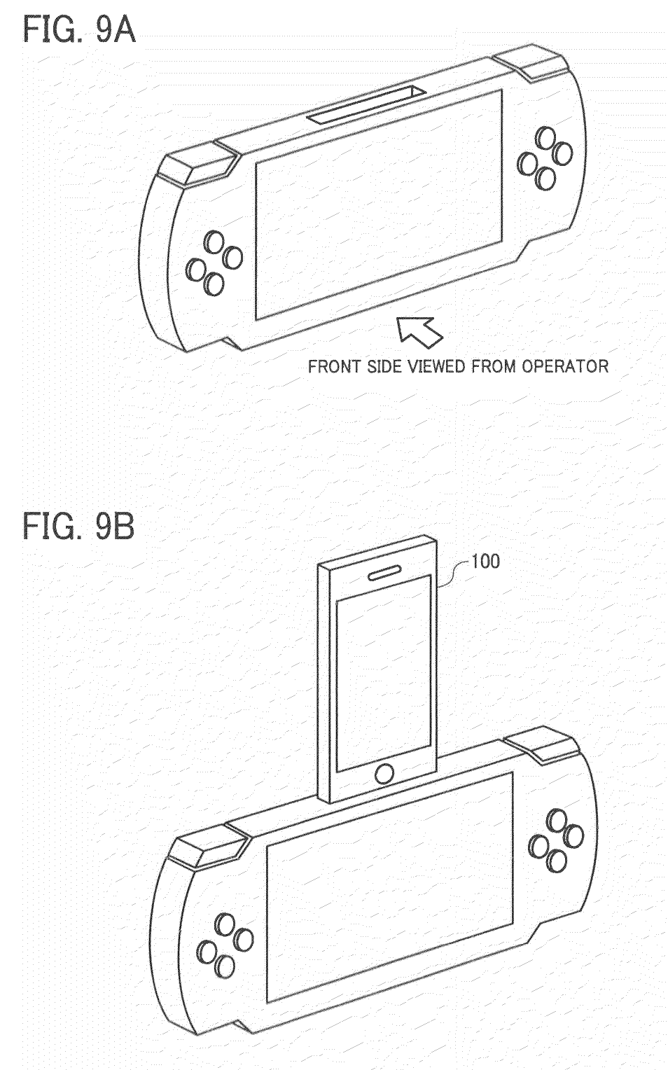

FIG. 9A is a perspective view of a game console. FIG. 9B is a schematic diagram that explains how the information processing apparatus 100 as a mobile terminal can be connected to the game console as a parent device. Particularly, as shown in FIG. 9B, the mobile terminal can be connected to the upper edge of the game console in a vertical posture.

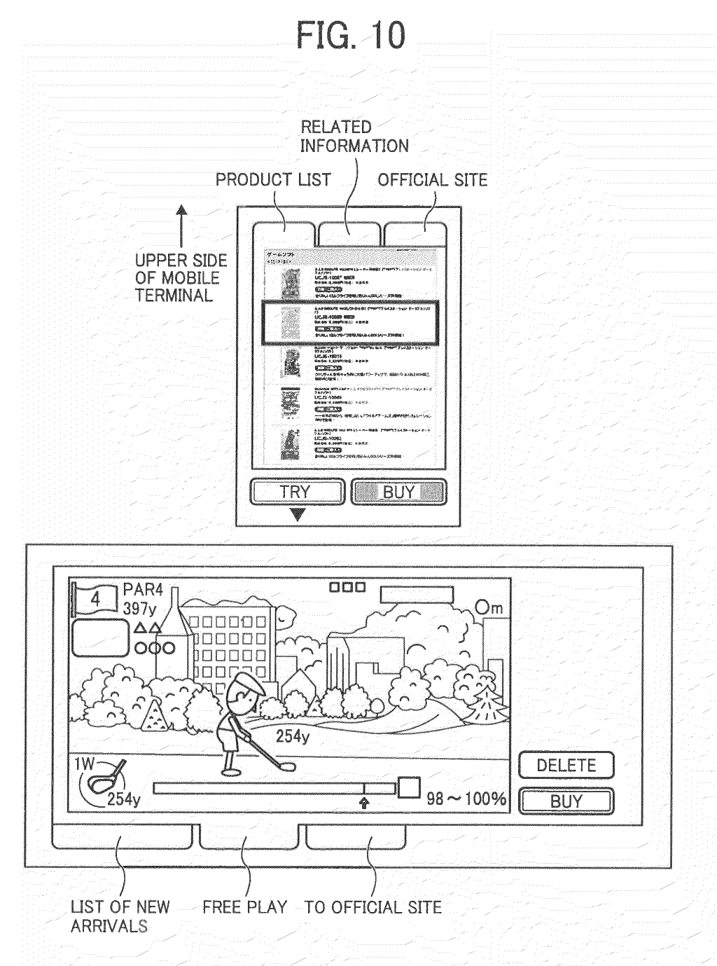

FIG. 10 is a schematic diagram of screens displayed on each of the game console and the mobile terminal when the mobile terminal is connected to the game console in the manner shown in FIG. 9B. In the example shown in FIG. 10, the display elements on the screen of each device are displayed in such a manner that the display elements do not hinder the cooperation with the other device in the same manner as the examples shown in FIGS. 4B and 4C. The arrangement positions of the display elements, such as tabs, on the screen of each device shown in FIG. 10 are the same as those shown in FIGS. 4B and 4C.

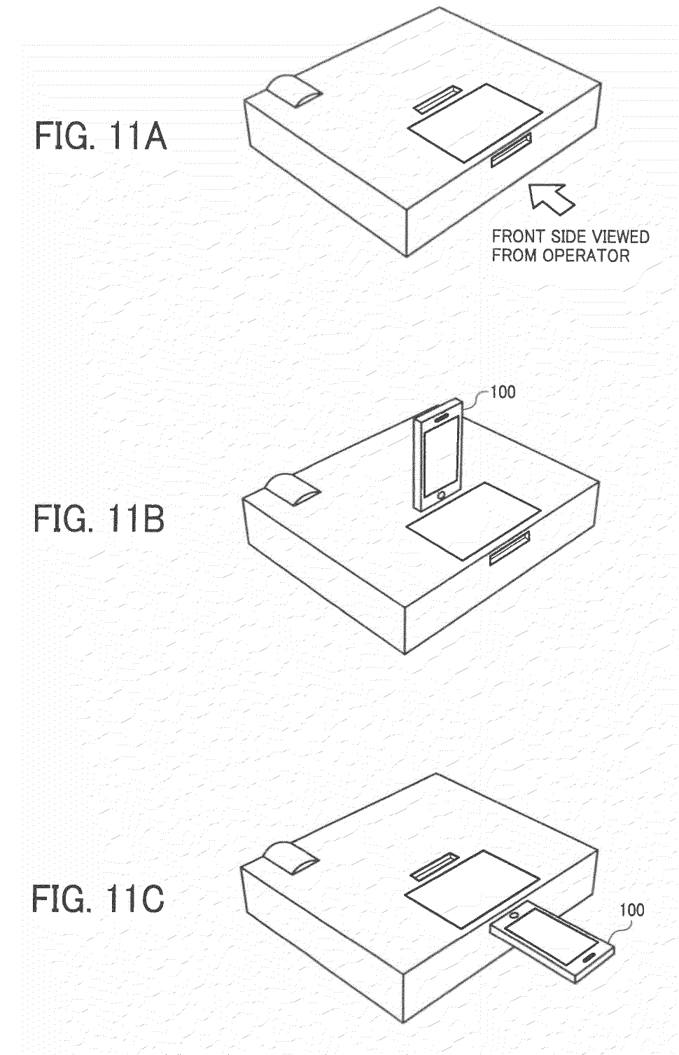

FIG. 11A is a perspective view of a projector. FIGS. 11B and 11C are diagrams that explain how the information processing apparatus 100 as a mobile terminal can be connected to the projector as a parent device. As shown in FIG. 11B the mobile terminal can be connected to the upper surface of the projector in a vertical posture, or as shown in FIG. 11C the mobile terminal can be connected to the front surface of the projector in a horizontal posture.

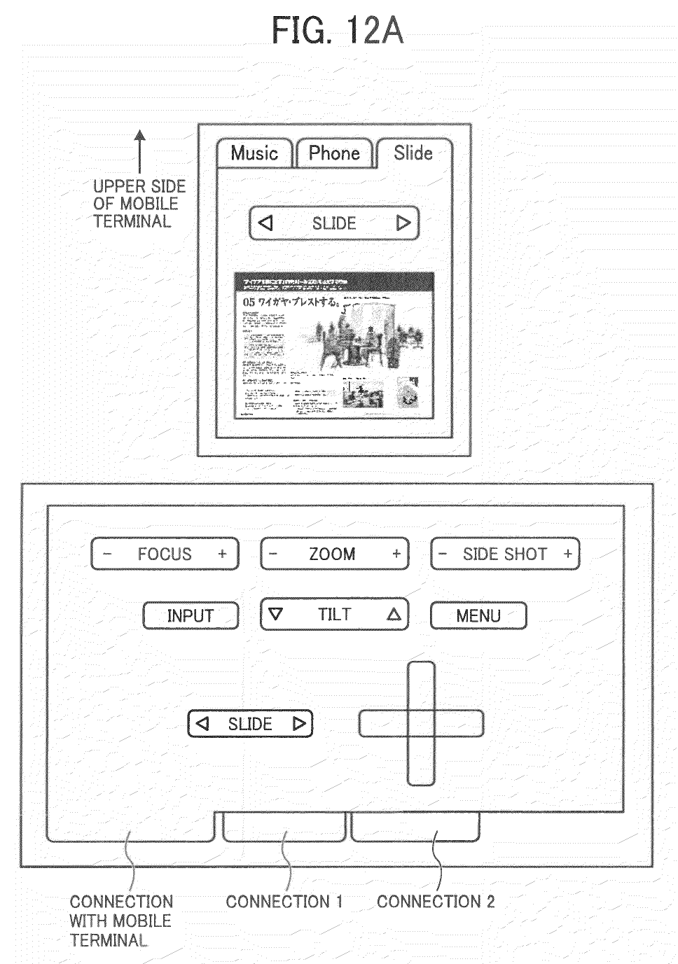

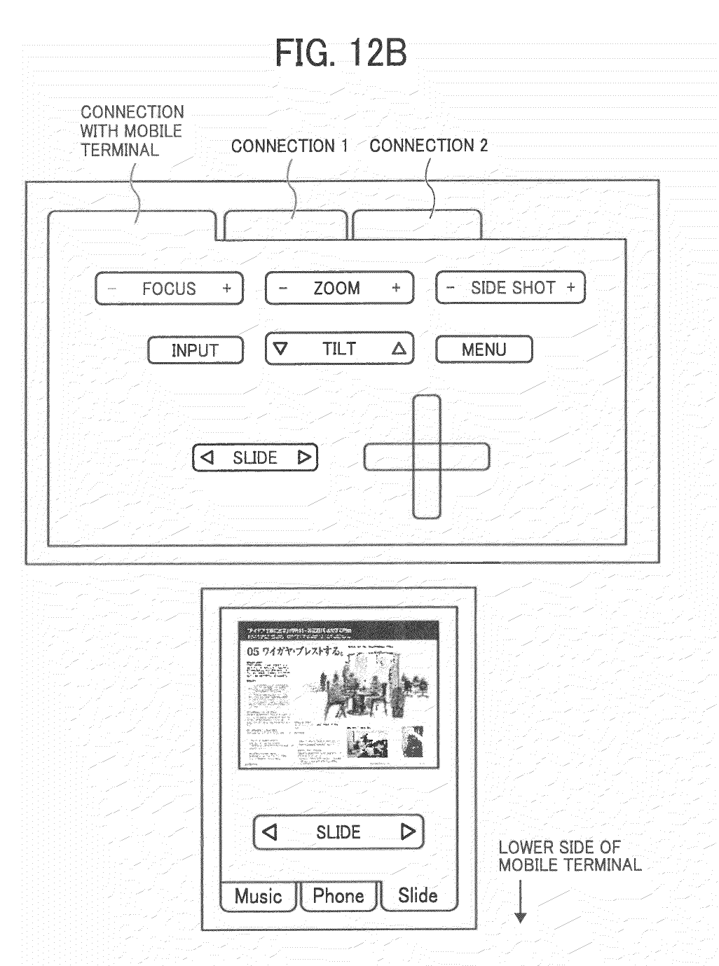

FIG. 12A and FIG. 12B are schematic diagrams that illustrate how screens are displayed on each of the projector and the mobile terminal shown in FIG. 11B and FIG. 11C respectively. FIG. 12A is a schematic diagram of screens displayed on the projector and the mobile terminal when the mobile terminal is connected to the upper surface of the projector in a vertical posture in a manner shown in FIG. 11B. FIG. 12B is a schematic diagram of screens displayed on the projector and the mobile terminal when the mobile terminal is connected to the front surface of the projector in a horizontal posture in a manner shown in FIG. 11C. In the examples shown in FIGS. 12A and 12B, the display elements on the screen of each device are displayed in such a manner that the display elements do not hinder the cooperation with the other device in the same manner as the examples shown in FIGS. 4B and 4C. The arrangement positions of the display elements, such as tabs, on the screen of each device shown in FIGS. 12A and 12B are the same as those shown in FIGS. 4B and 4C.

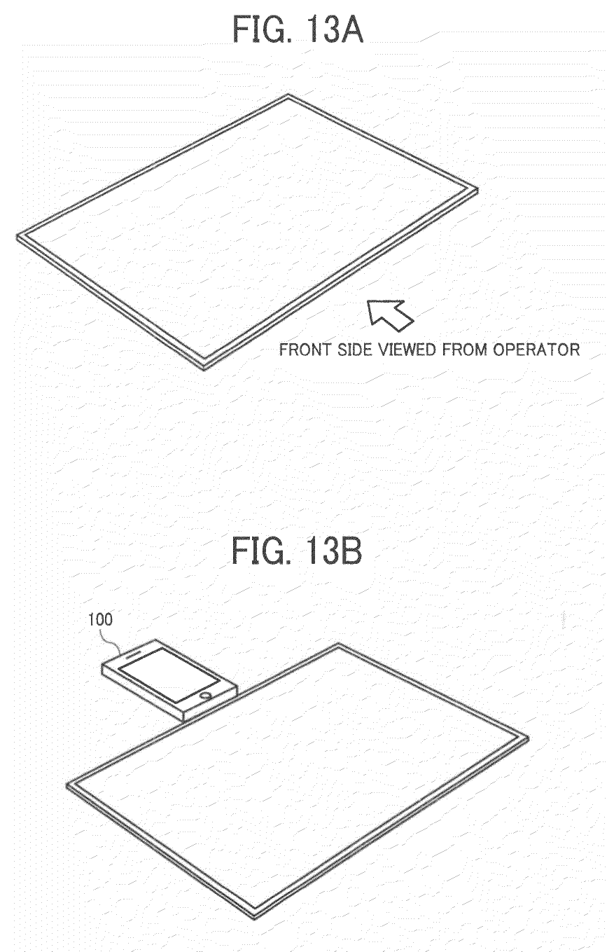

FIG. 13A is a perspective view of a electronic paper. FIG. 13B is a schematic diagram that explains how the information processing apparatus 100 as a mobile terminal can be connected to the electronic paper as a parent device. More particularly, as shown in FIG. 13B, the mobile terminal can be connected to the far side of the electronic paper in a horizontal posture.

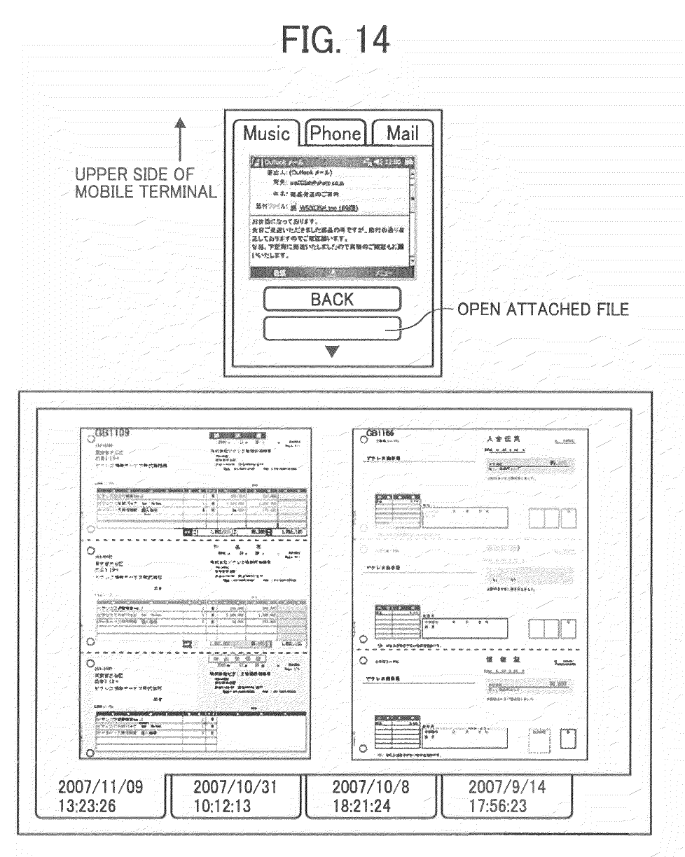

FIG. 14 is a schematic diagram of screens displayed on the electronic paper and the mobile terminal when the mobile terminal is connected to the far side of the electronic paper in the manner shown in FIG. 13B. In the example shown in FIG. 14, the display elements on the screen of each device are displayed in such a manner that the display elements do not hinder the cooperation with the other device in the same manner as the example shown in FIG. 4B. The arrangement positions of the display elements, such as tabs, on the screen of each device shown in FIG. 14 are the same as those shown in FIG. 4B.

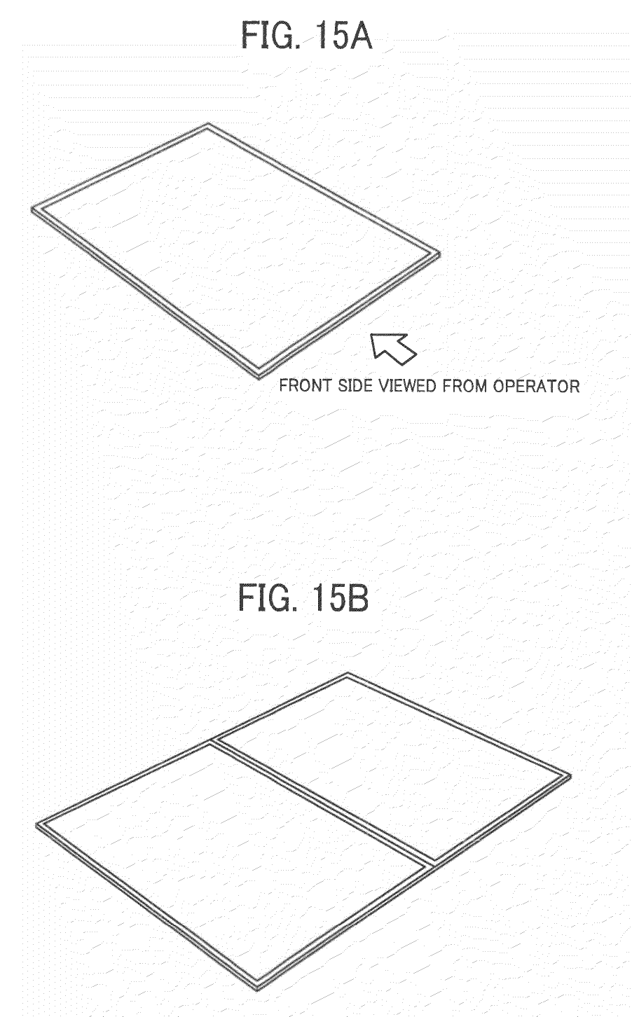

FIG. 15A is a perspective view of a sheet of the electronic paper. FIG. 15B is a diagram that explains how a sheet of the electronic paper as the information processing apparatus can be connected to the sheet of the electronic paper as the parent device. More particularly, as shown in FIG. 15B, the sheets of the electronic papers are connectable to each other side by side.

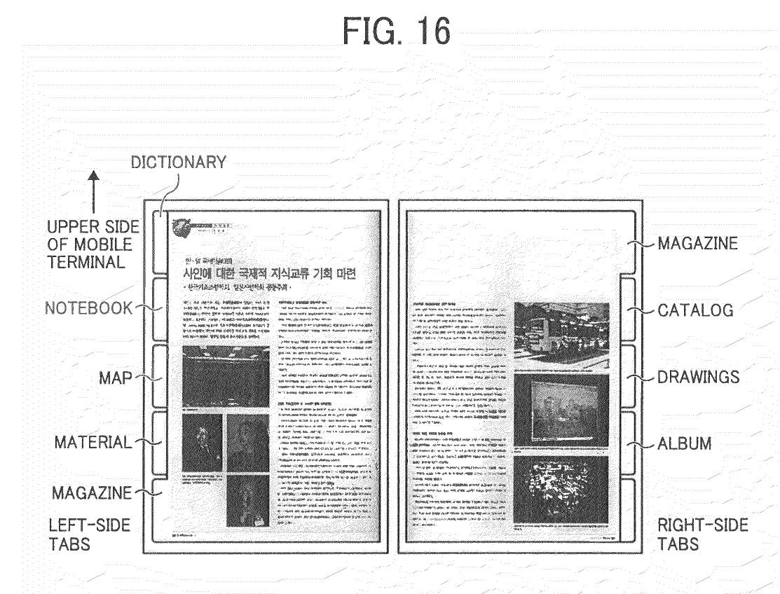

FIG. 16 is a schematic diagram of screens displayed on the two sheets of the electronic paper connected to each other in the manner shown in FIG. 15B. As shown in FIG. 16, the display elements on the screen of each device are displayed in such a manner that the display elements do not hinder the cooperation with the other device. More particularly, two pages are displayed arranged on the right side and the left side, respectively. The arrangement positions of the display elements, such as tabs, on the screen of each device shown in FIG. 16 are located on the right side and the left side so that the user can operate them easily.

In this manner, when the information processing apparatus according to the present embodiment is connected to another device, the information processing apparatus operates in cooperation with the another device so that the user operation becomes simpler.

A display processing program that is executed by the information processing apparatus according to the present embodiment can be stored, in a form of a file that is installable and executable on a computer, in a recording medium readable by the computer, such as a CD-ROM, a flexible disk (FD), a CD-R, and a digital versatile disk (DVD).

The display processing program that is executed by the information processing apparatus according to the present embodiment can be delivered, for example, in a state preinstalled into a ROM.

On the other hand, the display processing program that is executed by the information processing apparatus and the MFP according to the present embodiment can be stored in another computer connected to the computer via a network such as the Internet, and downloaded to the computer via the network. The display processing program that is executed by the information processing apparatus according to the present embodiment can be delivered or distributed via a network such as the Internet.

The display processing program that is executed by the information processing apparatus according to the present embodiment is, for example, made up of modules that implement the above-described units (the display control unit and the connection determining unit). When a CPU (processor) reads the display processing program from the ROM and executes the read display processing program, the above modules are loaded and created on a main memory thereby implementing the display control unit and the connection determining unit.

According to an aspect of the present invention, when an information processing apparatus is connected to another device, it operates in cooperation with the another device so that user operation becomes simpler.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a display unit;
a connection determining unit that determines whether the information processing apparatus is connected to an external device;
a receiving unit that receives, when the information processing apparatus is connected to the external device, external display data from the external device, wherein the external display data is a part of display data that forms a screen to be displayed on the display unit and includes a display element that does not hinder cooperation with the external device; and
a display control unit that forms the screen by using the external display data and causes the display unit to display the screen.

2. The information processing apparatus according to claim 1, wherein
the display control unit specifies an arrangement position in the screen of the display element included in the external display data.

3. The information processing apparatus according to claim 2, wherein the display control unit specifies the arrangement position of the display element so that the display element is displayed on the display unit of the information processing apparatus in an arrangement position that is inverse to the arrangement position of the display element displayed on the external device.

4. The information processing apparatus according to claim 3, wherein the display control unit specifies the arrangement position of the display element on the screen so that the display element is located near to where a user is positioned.

5. A display processing method to be implemented on an information processing apparatus having a display unit, the display processing method comprising:
determining whether the information processing apparatus is connected to an external device;
receiving, when the information processing apparatus is determined to be connected to the external device at the determining, external display data from the external device, wherein the external display data is a part of display data that forms a screen to be displayed on the display unit and includes a display element that does not hinder cooperation with the external device; and
forming the screen by using the external display data and causing the display unit to display the screen.

6. The display processing method according to claim 5, wherein the forming includes specifying an arrangement position in the screen of the display element included in the external display data.

7. The display processing method according to claim 6, wherein the specifying includes specifying the arrangement position of the display element so that the display element is displayed on the display unit of the information processing apparatus in an arrangement position that is inverse to the arrangement position of the display element displayed on the external device.

8. The display processing method according to claim 7, wherein the specifying includes specifying the arrangement position of the display element on the screen so that the display element is located near to where a user is positioned.

9. A computer program product including computer program codes stored on a computer-readable recording medium which when executed on a computer cause the computer to execute a display processing method to be implemented on an information processing apparatus having a display unit, the computer program codes causing the computer to execute:
determining whether the information processing apparatus is connected to an external device;
receiving, when the information processing apparatus is determined to be connected to the external device at the determining, external display data from the external device, wherein the external display data is a part of display data that forms a screen to be displayed on the display unit and includes a display element that does not hinder cooperation with the external device; and
forming the screen by using the external display data and causing the display unit to display the screen.
